(19) United States
(12) Patent Application Publication
(10) Pub. No.: US 2024/0229206 A1
(43) Pub. Date: Jul. 11, 2024

(54) FE-BASED AMORPHOUS ALLOY AND FE-BASED AMORPHOUS ALLOY RIBBON

(71) Applicant: NIPPON STEEL CORPORATION, Tokyo (JP)

(72) Inventors: Shinya SATO, Tokyo (JP); Shigekatsu OZAKI, Tokyo (JP); Shinichi TERASHIMA, Tokyo (JP); Takayuki KOBAYASHI, Tokyo (JP); Yuichi SATO, Tokyo (JP)

(73) Assignee: NIPPON STEEL CORPORATION, Tokyo (JP)

(21) Appl. No.: 18/562,224

(22) PCT Filed: May 18, 2022
(86) PCT No.: PCT/JP2022/020729

§ 371 Date: Nov. 17, 2023

(30) Foreign Application Priority Data
May 18, 2021 (JP) 2021-083748
Jan. 24, 2022 (JP) 2022-008724

(51) Int. Cl. C22C 45/02

(52) U.S. Cl. CPC C22C 45/02; C22C 2200/02

(57) ABSTRACT

The present invention has as its object the provision of an Fe-based amorphous alloy and Fe-based amorphous alloy ribbon excellent in soft magnetic properties having a low iron loss and a high saturation magnetic flux density. The Fe-based amorphous alloy excellent in soft magnetic properties of the present invention comprises, by atom %, B: 8.0% or more and 18.0% or less, Si: 2.0% or more and 9.0% or less, C: 0.10% or more and 5.00% or less, Al: 0.005% or more and 1.50% or less, P: 0% or more and less than 1.00%, Mn: 0% or more and 0.30% or less, Fe: 78.00% or more and 86.00% or less, and balance: impurities and has an amorphous structure.

### FIELD

The present invention relates to an Fe-based amorphous alloy excellent in soft magnetic properties and an Fe-based amorphous alloy ribbon excellent in soft magnetic properties.

### BACKGROUND

As methods for continuously producing ribbon or wire by quenching an alloy from a molten state, the centrifugal quenching method, single roll method, twin roll method, etc. are known. These methods eject molten metal from an orifice etc. onto an inner circumferential surface or outer circumferential surface of a high speed rotating metal drum to thereby rapidly make the molten metal solidify and produce a ribbon or wire. Further, by suitably selecting the alloy composition, it is possible to obtain an amorphous alloy resembling the liquid metal and possible to produce a material excellent in magnetic properties or mechanical properties.

In particular, among amorphous alloys, Fe-based amorphous alloys are viewed as promising for applications of iron cores etc. of power transformers and high frequency transformers. To improve the performances in these applications, lower iron loss and higher magnetic flux density are being strongly sought from Fe-based amorphous alloys.

PTL 1 describes an amorphous alloy ribbon excellent in magnetic properties characterized comprising an alloy expressed by TMₐSi_{b}B_{c}C_{d}Mₑ (where TM is at least one element of Fe, Co, and Ni, M is at least one element of Al, Ti, and Zr, “a” to “e” are, by atom %, a: 70 to 85, b: 4 to 18, c: 7 to 18, d: 0 to 4, and e: 0.01 to 0.3, and a+b+c+d+e=100), being produced by ejecting a melt of the alloy through a multilayer slit nozzle having several apertures on to a moving cooling substrate so as to quench and solidify it, and having at least one crystallized layer at an inside of the ribbon thickness.

PTL 2 describes an Fe-based amorphous alloy excellent in soft magnetic properties containing, by atom %, Fe in 80.0% or more and 88.0% or less, B in 6.0% or more and 12.0% or less, C in 2.0% or more and 8.0% or less, Si in 0.10% or more and 3.0% or less, and Al in 0.10% or more and 2.0% or less, further containing Mo in 0.10% or more and 6.0% or less, and having a balance of unavoidable impurities.

PTL 3 describes an iron core use amorphous alloy expressed by formula: FeₐB_{b}P_{c}Si_{d}CₑX_{f} having a high saturation magnetic flux density (where, X is one or more elements selected from Al, Sn, Ge, Ti, Zr, Nb, V, Mo, and W, “b” for B is 1 to 5 atom %, “c” for P is 1 to 10 atom %, “d” for Si is 4 to 14 atom %, “e” for C is 5 atom % or less, “f” for X is 5 atom % or less, and “a” for Fe is (100−(b+c+d+e+f)) atom %).

PTL 4 describes an amorphous soft magnetic alloy containing Fe_{100-x-y-z}SiₓB_{y}P_{z} (atom %) as a main constituent, where “x”, “y”, and “z” respectively satisfy 0.5≤x≤15, 5≤y≤25, z≤15, 18≤x+y+z≤30, and, with respect to the main constituent, Mn in 0.01 mass % or more and 0.3 mass % or less, Al in 0.0001 mass % or more and 0.01 mass % or less, Ti in 0.001 mass % or more and 0.03 mass % or less, Cu in 0.005 mass % or more and 0.2 mass % or less, and S in 0.001 mass % or more and 0.05 mass % or less.

PTL 5 describes an Fe-based amorphous alloy ribbon comprised of a metal ribbon obtained by ejecting molten metal onto a moving cooling substrate through an ejection nozzle having a slot-shaped aperture to quench and solidify the same and having an extremely thin oxide layer of a thickness of 5 nm or more and 20 nm or less on at least one ribbon surface of an amorphous matrix phase containing 0.2 atom % or more and 12 atom % or less of P.

The various ribbons and alloys described in PTLs 1 to 5 have certain soft magnetic properties, but there is room for further improvement of the soft magnetic properties.

### CITATIONS LIST

### Patent Literature

[PTL 1] Japanese Unexamined Patent Publication No. 4-362162
[PTL 2] Japanese Unexamined Patent Publication No. 2017-78186
[PTL 3] Japanese Unexamined Patent Publication No. 57-185957
[PTL 4] Japanese Unexamined Patent Publication No. 2009-174034
[PTL 5] WO2003/085150

### SUMMARY

### Technical Problem

Fe-based amorphous alloys are viewed as promising for applications of iron cores of power transformers and high frequency transformers etc. To improve the performances in these applications, lower iron loss and higher magnetic flux density are being strongly sought from Fe-based amorphous alloys. The present invention has as its object the provision of an Fe-based amorphous alloy and Fe-based amorphous alloy ribbon excellent in soft magnetic properties having a low iron loss and a high saturation magnetic flux density.

### Solution to Problem

To solve the above technical issues, the present invention adopts the following constitutions:

[1] An Fe-based amorphous alloy comprising, by atom %, B: 8.0% or more and 18.0% or less, Si: 2.0% or more and 9.0% or less, C: 0.10% or more and 5.00% or less, Al: 0.005% or more and 1.50% or less, P: 0% or more and less than 1.00%, Mn: 0% or more and 0.30% or less, Fe: 78.00% or more and 86.00% or less, and balance: impurities and having an amorphous structure.

[2] The Fe-based amorphous alloy of the above [1], wherein, by atom %, the content of B is 10.0% or more and 18.0% or less, the content of Si is 2.0% or more and 6.0% or less, the content of C is 0.10% or more and less than 3.00%, and the content of P is 0% or more and 0.05% or less.

[3] The Fe-based amorphous alloy of the above [1], wherein, by atom %, the content of B is 11.0% or more and 16.0% or less, the content of Si is 2.0% or more and 4.0% or less, the content of C is 0.10% or more and less than 3.00%, and the content of P is 0% or more and 0.05% or less.

[4] The Fe-based amorphous alloy of the above [1], wherein, by atom %, the content of B is 8.0% or more and 16.0% or less, the content of Si is more than 2.0% and 9.0% or less, the content of Al is 0.005% or more and 1.00% or less, and the content of P is 0.01% or more and less than 1.00% and the sum of the contents of P and Al 0.10% or more and 1.50% or less.

[5] The Fe-based amorphous alloy of the above [1], wherein, by atom %, the content of B is 8.0% or more and 15.0% or less, the content of Si is more than 3.0% and 7.5% or less, the content of C is 0.50% or more and 5.00% or less, the content of Al is 0.01% or more and 0.80% or less, the content of P is 0.01% or more and 0.80% or less, and the content of Fe is 78.00% or more and 85.00% or less and the sum of the contents of P and Al is 0.10% or more and 1.50% or less.

[6] The Fe-based amorphous alloy of the above [1], wherein, by atom %, the content of B is 10.0% or more and 16.0% or less, the content of Si is more than 2.0% and 6.0% or less, the content of C is 0.10% or more and less than 3.00%, the content of Al is 0.01% or more and 1.00% or less, the content of P is 0.01% or more and less than 1.00%, and the content of Fe is 78.00% or more and 84.00% or less and the sum of the contents of P and Al is 0.10% or more and 1.50% or less.

[7] The Fe-based amorphous alloy of any one of the above [1] to [6], wherein at least one or more elements among Ni, Cr, and Co replaces the Fe in 10.0 atom % or less in range.

[9] An Fe-based amorphous alloy ribbon comprised of the Fe-based amorphous alloy of any one of the above [1] to [7].

### Advantageous Effects of Invention

According to the present invention, it is possible to provide an Fe-based amorphous alloy and Fe-based amorphous alloy ribbon excellent in soft magnetic properties having a low iron loss and a high saturation magnetic flux density.

### DESCRIPTION OF EMBODIMENTS

The inventors took note of compositions mainly comprised of Fe and including B, C, and Si among the various alloy compositions proposed up to now and engaged in studies and experiments for realizing low iron loss while maintaining a high magnetic flux density. Further, they focused on Al, which in the past had been considered disadvantageous for making a amorphous structure. Al, as clear from PTL 1 as well in which it is used as an element forming a crystalline phase at the ribbon surface, had been known in the past as an element easily forming a crystalline phase. On the other hand, as described in PTL 2, it was found that by adding Al and Si, the thermal stability of the amorphous phase is improved.

Therefore, the inventors conducted detailed experiments on systems of compositions comprised mainly of Fe and having mainly B, C, and Si as added elements and, as a result, discovered that by inclusion of a small amount of Al, the iron loss can be lowered. Further, they discovered optimal ranges of contents of Si, C, and B for making up for the drop in the amorphous layer forming ability due to the inclusion of Al. Due to this, without requiring the addition of Mo such as described in PTL 2, it became possible to make the saturation magnetic flux density 1.60 T or more, preferably 1.62 T or more, and make the iron loss at a magnetic flux density 1.3 T and frequency 50 Hz (iron loss W_{13/50}) 0.095 W/kg or less, preferably 0.090 W/kg or less, and thereby completed the invention relating to an Fe-based amorphous alloy simultaneously exhibiting high saturation magnetic flux density and low iron loss.

Below, the Fe-based amorphous alloy and Fe-based amorphous alloy ribbon excellent in soft magnetic properties of the present embodiment will be explained. In the present embodiment, “excellent in soft magnetic properties” means having the properties of a low iron loss and high saturation magnetic flux density. Below, the “%” expressing the contents of elements shall mean “atom %” unless otherwise indicated.

The Fe-based amorphous alloy of the present embodiment contains B in 8.0% or more and 18.0% or less, Si in 2.0% or more and 9.0% or less, C in 0.10% or more and 5.00% or less, Al in 0.005% or more and 1.50% or less, P in 0% or more and less than 1.00%, Mn in 0% or more and 0.30% or less, and Fe in 78.00% or more and 86.00% or less and, as a balance, is allowed to include a total amount of 0.10% or less of impurities.

The above Fe-based amorphous alloy of the present embodiment may also contain B in 10.0% or more and 18.0% or less, Si in 2.0% or more and 6.0% or less, C in 0.10% or more and less than 3.0%, Al in 0.005% or more and 1.50% or less, P in 0% or more and 0.05% or less, Mn in 0% or more and 0.30% or less, and Fe in 78.00% or more and 86.00% or less.

The above Fe-based amorphous alloy of the present embodiment may also contain B in 11.0% or more and 16.0% or less, Si in 2.0% or more and 4.0% or less, C in 0.10% or more and less than 3.0%, Al in 0.005% or more and 1.50% or less, P in 0% or more and 0.050% or less, Mn in 0% or more and 0.30% or less, and Fe in 78.00% or more and 86.00% or less.

The above Fe-based amorphous alloy, to improve the workability, can contain B in 8.0% or more and 16.0% or less, Si in more than 2.0% and 9.0% or less, C in 0.10% or more and 5.00% or less, Al in 0.005% or more and 1.00% or less, P in 0.01% or more and less than 1.00%, and Fe in 78.0% or more and 86.0% or less and have a sum of the contents of P and Al of 0.10% or more and 1.50% or less.

The Fe-based amorphous alloy of the present embodiment improved in workability may also contain B in 8.0% or more and 15.0% or less, Si in more than 3.0% and 7.5% or less, C in 0.50% or more and 5.00% or less, Al in 0.01% or more and 0.80% or less, P in 0.01% or more and 0.80% or less, Mn in 0% or more and 0.30% or less, and Fe in 78.0% or more and 85.0% or less and have a sum of the contents of P and Al of 0.10% or more and 1.50% or less.

In the Fe-based amorphous alloy of the present embodiment improved in workability, the above Fe-based amorphous alloy may also contain B in 10.0% or more and 16.0% or less, Si in more than 2.0% and 6.0% or less, C in 0.10% or more and less than 3.00%, Al in 0.01% or more and 1.00% or less, P in 0.01% or more and less than 1.00% Mn in 0% or more and 0.30% or less, and Fe in 78.00% or more and 84.00% or less.

In the present embodiment, “excellent in workability” means a ribbon comprised of the Fe-based amorphous alloy having a good strip tear ductility. A “good strip tear ductility” means few number of brittle spots forming when tearing a certain length of Fe-based amorphous alloy ribbon in the casting direction. “Brittle spots” mean regions where damage to the Fe-based amorphous alloy ribbon such as changes in the route and direction of the tear and breaking into pieces occurs when tearing the Fe-based amorphous alloy ribbon.

Further, the Fe-based amorphous alloy of the present embodiment may have at least one element or more of Ni, Cr, and Co replace the Fe of the above Fe-based amorphous alloy in 10.0% or less in range.

Further, the Fe-based amorphous alloy ribbon of the present embodiment is comprised of the above Fe-based amorphous alloy.

Below, the reasons for limitation of the contents of the elements in the Fe-based amorphous alloy of the present embodiment will be explained.

B is included in the Fe-based amorphous alloy of the present embodiment so as to improve the formation of the amorphous phase and thermal stability of the amorphous phase. By optimizing the contents of these elements, it becomes possible to cancel out the drop in the the amorphous phase forming ability accompanying the inclusion of Al and stably make the alloy microstructure an amorphous phase and possible to further improve the soft magnetic properties. For example, it is possible to stably make the saturation magnetic flux density 1.60 T or more. If B is less than 8.0%, no improvement of the amorphous phase forming ability is obtained, an amorphous alloy can no longer be stably obtained in the Fe-based amorphous alloy, and it becomes difficult to stably make the saturation magnetic flux density 1.60 T or more while stably maintaining the iron loss at 0.095 W/kg or less. On the other hand, even if B is more than 18.0%, no improvement of the amorphous phase forming ability is obtained and it becomes difficult to stably make the saturation magnetic flux density 1.60 T or more. Therefore, B is limited to 8.0% or more and 18.0% or less in range. The content of B may also be made 9.0% or more, 10.0% or more, 11.0% or more, or 11.5% or more. Further, the content of B may also be made 17.0% or less, 16.0% or less, 15.5% or less, or 15.0% or less.

Si and C, like B, are contained in the Fe-based amorphous alloy of the present embodiment so as to form an amorphous phase and raise the thermal stability of the amorphous phase. By optimizing the contents of these elements, it becomes possible to cancel out the drop in the the amorphous phase forming ability accompanying the inclusion of Al and stably make the alloy microstructure an amorphous phase and possible to further improve the soft magnetic properties. For example, it is possible to stably make the saturation magnetic flux density 1.60 T or more.

If Si is less than 2.0% and C is less than 0.10%, no improvement of the amorphous phase forming ability is obtained, amorphous alloy can no longer be stably obtained in the Fe-based amorphous alloy, and it becomes difficult to stably make the saturation magnetic flux density 1.60 T or more while stably maintaining the iron loss at 0.095 W/kg or less. On the other hand, even if making Si more than 9.0% and C more than 5.0%, no improvement of the amorphous phase forming ability is obtained and it becomes difficult to stably make the saturation magnetic flux density 1.60 T or more. Therefore, Si is limited to 2.0% or more and 9.0% or less and C to 0.10% or more and 5.00% or less in range.

The content of Si may also be made 2.2% or more, 2.5% or more, 2.8% or more, or or 3.0% or more. Further, the content of Si may also be made 7.0% or less, 6.0% or less, 4.0% or less, or 3.5% or less.

The content of C may also be made 0.20% or more, 0.30% or more, 0.40% or more, or 0.50% or more. Further, the content of C may also be made less than 3.00%, less than 2.50%, less than 2.00%, and less than 1.50%.

Al is made to be included to realize low iron loss in the Fe-based amorphous alloy of the present embodiment. However, if the content of Al increases, the amorphous phase forming ability falls and an amorphous alloy is not stably obtained, so stably making the saturation magnetic flux density 1.60 T or more becomes difficult. Therefore, the Al content is made 0.005 to 1.50% in range. The Al content may also be 0.008% or more, 0.010% or more, 0.05% or more, 0.10% or more, or 0.20% or more. Further, the Al content may also be 1.40% or less, 1.30% or less, 1.20% or less, 1.00% or less, or 0.80% or less.

P, like Si, C, and B, is made to be included so as to form an amorphous phase and raise the thermal stability of the amorphous phase. By optimizing the content of the element, it becomes possible to cancel out the drop in the the amorphous phase forming ability accompanying the inclusion of Al and stably make the alloy microstructure an amorphous phase. It may be included to improve the workability of the Fe-based amorphous alloy to raise the strip tear ductility in the case of making the Fe-based amorphous alloy ribbon. It is not an essential element, so the lower limit of the content is 0. The effects can be obtained even with inclusion in a trace amount, but to reliably obtain the effect of improvement of the workability, the content of P is preferably made 0.010% or more. On the other hand, if making the content of P 1.00% or more, there is a possibility of the workability falling. Therefore, P is preferably limited to 0.010% or more and less than 1.00% in range. The content of P may be 0.03% or more, 0.05% or more, 0.10% or more, 0.15% or more, or 0.20% or more. Further, the content of P may be made 0.95% or less, 0.90% or less, 0.80% or less, or 0.70% or less.

Mn may be included since it has the effect of reducing the iron loss of the Fe-based amorphous alloy. It is not an essential element, so the lower limit of the content is 0. The effect of reduction of the iron loss can be obtained even with inclusion in a trace amount, but to reliably obtain the effect of reduction of the iron loss, inclusion of 0.10% or more is preferable. On the other hand, if the content of Mn is more than 0.30%, there is a possibility of the saturation magnetic flux density falling. Therefore, the content of Mn is made 0.30% or less. The content of Mn may also be 0.12% or more, 0.13% or more, 0.14% or more, or 0.15% or more. Further, the content of Mn may also be 0.28% or less, 0.25% or less, 0.22% or less, or 0.20% or less.

Furthermore, from the viewpoint of the balance of the iron loss and workability, the sum of the contents of P and Al is preferably limited to 0.10% or more and 1.50% or less in range. By P and Al being included, the iron loss is reduced, but if the contents are too great, the workability and iron loss deteriorate, so there is an optimal range to the sum of the contents of P and Al. The total amount of P and Al may be 0.15% or more, 0.20% or more, 0.30% or more, or 0.40% or more. Further, the total amount of P and Al may be 1.40% or less, 1.35% or less, 1.30% or less, or 1.20% or less.

In an Fe-based amorphous alloy, if the content of Fe is 70% or more, usually a saturation magnetic flux density of a practical level for a general iron core is obtained, but to obtain a 1.60 T or more high saturation magnetic flux density, Fe has to be made 78.00% or more. On the other hand, if the content of Fe becomes greater, formation of an amorphous phase becomes difficult and sometimes it becomes difficult to obtain the excellent soft magnetic properties distinctive to amorphous alloys (iron loss W_{13/50} becoming stably 0.095 W/kg or less), so the contents of the other elements are adjusted to the above ranges so that the Fe content becomes 86.00% or less. The content of Fe may also be 78.50% or more, 79.00% or more, 79.50% or more, or 80.00% or more. Further, the content of Fe may also be 85.50% or less, 85.00% or less, 84.00% or less, or 83.00% or less.

In the Fe-based amorphous alloy according to the present embodiment, in addition to the above elements, inclusion of a total of 0.10% or less of impurities is allowed. If the total of the impurities is 0.10% or less, there is no effect on the solution of the problem of the present invention of obtaining a Fe-based amorphous alloy and Fe-based amorphous alloy ribbon excellent in soft magnetic properties having a low iron loss and a high saturation magnetic flux density.

If using a ferrous material as an Fe source, the impurities include the impurity elements contained in the ferrous material. For example, Ti, N, S, O, etc. may be contained as impurities. The guidelines of the amounts of elements contained as impurities are 0.005% or less for Ti and S, 0.02% or less for N, and 0.05% or less for O. Further, P, even when not intentionally included, is sometimes included as an impurity in 0.05% or less or so. If P is included as an impurity, it is included in preferably 0.04% or less, more preferably 0.03% or less, still more preferably 0.02% or less.

The amounts of these impurities are guidelines. As explained above, if the total amount of the impurities is 0.10% or less, there is no effect on the solution to the problem of the present invention. The total amount of the impurities may also be 0.08% or less, 0.06% or less, or 0.05% or less.

Further, by using at least one or more of Ni, Cr, and Co to replace the Fe of the Fe-based amorphous alloy in 10.0% or less in range, it is possible to realize improvement of the iron loss and other soft magnetic properties while maintaining a high saturation magnetic flux density. An upper limit is set on the amount of replacement by these elements because if more than 10.0%, the saturation magnetic flux density becomes lower and the material cost mounts up. If replacing Fe with one or more of Ni, Cr, and Co, the total of the contents of Ni, Cr, and Co and the content of Fe need only be 78.00% or more and 86.00% or less. The total of the contents of Ni, Cr, and Co and the content of Fe may be 78.50% or more, 79.00% or more, 79.50% or more, or 80.00% or more. Further, the total of the contents of Ni, Cr, and Co and the content of Fe may also be 85.50% or less, 85.00% or less, 84.00% or less, or 83.00% or less.

The Fe-based amorphous alloy of the present embodiment usually can be obtained in the form of a ribbon. This Fe-based amorphous alloy ribbon can be produced by the method of melting an alloy comprised of the constituents explained in the above embodiments and ejecting the melt through a slot nozzle etc. onto a cooling plate moving at a high speed to quench and solidify the melt, for example, the single roll method or twin roll method. The rolls used for these roll methods are made of metal. An alloy can be quenched and solidified by making a roll rotate and a high speed and making a melt strike the roll surface or the inner circumference of the roll.

The “single roll apparatus” includes ones equipped with centrifugal quenching devices using inside walls of drums, devices using endless type belts, auxiliary rolls of improved types of these, and roll surface temperature control devices and casting devices under reduced pressure or in a vacuum or inert gas.

In the present embodiment, the thickness, width, and other dimensions of the ribbon are not particularly limited, but the thickness of the ribbon is for example preferably 10 μm or more and 100 μm or less.

Further, the width is preferably 10 mm or more. The Fe-based amorphous alloy ribbon obtained as explained above can be used for applications such as iron cores of power transformers or high frequency transformers.

Note that, the Fe-based amorphous alloy of the present embodiment can be rendered a powder in form in addition to a ribbon. In this case, the method may be employed of ejecting an alloy melt or liquid drops of an alloy melt at a high speed from a nozzle of a crucible filled with an alloy melt of the above composition onto a rotating roll or into cooling use water or other liquid to quench and solidify the same.

Using the above-mentioned methods, a Fe-based amorphous alloy powder excellent in soft magnetic properties can be obtained.

The Fe-based soft magnetic alloy powder obtained as explained above can be compacted and formed into the target shape by a mold etc. and, if needed, sintered to an integral piece to be able to used for applications such as iron cores of power transformers, high frequency transformer, or coils.

Note that, whether the Fe-based amorphous alloy of the present embodiment has an amorphous structure can be confirmed for example by X-ray diffraction analysis using an X-ray diffraction apparatus using a Co tube. That is, if no clear diffraction peaks can be obtained in X-ray diffraction analysis, it can be confirmed that the Fe-based amorphous alloy has an amorphous structure and there is no crystalline phase present.

The Fe-based amorphous alloy of the present embodiment and Fe-based amorphous alloy ribbon being excellent in soft magnetic properties means the case where the saturation magnetic flux density becomes 1.60 T or more and the iron loss (iron loss W_{13/50}) at the magnetic flux density 1.3 T and frequency 50 Hz becomes 0.095 W/kg or less when measuring the saturation magnetic flux density and iron loss by the methods explained next.

The iron loss is measured using an SST (single ribbon tester). The measurement conditions of the iron loss are a magnetic flux density 1.3 T and a frequency 50 kHz. Samples for measurement of the iron loss are taken from six locations across the entire length of one lot of ribbon. The samples for measurement of iron loss are made samples of the ribbon cut into 120 mm lengths. The samples of ribbons for measurement of iron loss are annealed at 360° C. for 1 hour in a magnetic field (magnetic field: 800 A/m, magnetic field applied in casting direction) and used for measurement. The atmosphere during the annealing is made a nitrogen atmosphere. On the other hand, the saturation magnetic flux density is measured using a VSM (vibrating sample magnetometer). Samples for the VSM are made thin pieces taken from the center parts of width of the samples of ribbons from the six locations.

According to the Fe-based amorphous alloy of the present embodiment and Fe-based amorphous alloy ribbon, by including Al, by optimizing the contents of B, Si, and C, and further by making the content of Fe 78.00% or more, the iron loss (iron loss W_{13/50}) at the magnetic flux density 1.3 T and frequency 50 Hz becomes 0.095 W/kg or less, the saturation magnetic flux density becomes 1.60 T or more, and excellent soft magnetic properties can be exhibited. These can be optimally used for the iron cores of power transformers or high frequency transformers etc.

The Fe-based amorphous alloy of the present embodiment and Fe-based amorphous alloy ribbon can be given excellent workability as an additional effect. Excellent workability specifically means a Brittleness Code of 4 or less in the evaluation of the strip tear ductility prescribed in JIS C 2534: 2017. A Brittleness Code of 4 or less means a number of brittle spots in one test piece of nine or less.

According to these additional effects, in the evaluation of the strip tear ductility prescribed in JIS C 2534: 2017, the Brittleness Code becomes 4 or less. Due to this, in the process of working the cast Fe-based amorphous alloy ribbon into the final product, for example, even in the case of slitting or cutting, cracking can be suppressed and the yield in the production of products can be improved.

### EXAMPLES

Below, examples of the present invention will be explained.

### Examples 1

An alloy of each of the various compositions shown in Table 1 was melted in an argon atmosphere and quenched and cast by a single roll apparatus so as to prepare a ribbon of an Fe-based amorphous alloy. The casting atmosphere was the air. Note that, the single roll apparatus used was comprised of a diameter 300 mm copper alloy cooling roll, a high frequency power source for melting a sample, a quartz crucible with a slot nozzle at the front end, etc. In this test, a length 10 mm, width 0.6 mm slot nozzle was used. The peripheral speed of the cooling roll was made 24 m/s. As a result, the thickness of the obtained ribbon was about 20 μm. The width depends on the length of the slot nozzle, so was 10 mm. The length was around 100 m.

The obtained Fe-based amorphous alloy ribbon was analyzed by X-ray diffraction to obtain an X-ray diffraction pattern. The X-ray source for X-ray diffraction was made Co-Kα (wavelength λ=1.7902 Å) while the scan range was made 2θ=10 deg or more and 120 deg or less. From the shape of the X-ray diffraction pattern, it was judged whether a crystalline phase was formed in the metallographic microstructure.

Further, the saturation magnetic flux density and iron loss of the Fe-based amorphous alloy ribbon were measured using an SST (single ribbon tester). Note that, the measurement conditions of the iron loss were a magnetic flux density 1.3 T and frequency 50 kHz. Samples for measurement of the iron loss were taken from six locations across the entire length of one lot of ribbon. The samples for measurement of iron loss were made samples of the ribbon cut into 120 mm lengths. The samples of ribbons for measurement of iron loss were annealed at 360° C. for 1 hour in a magnetic field (magnetic field: 800 A/m, magnetic field applied in casting direction) and used for measurement. The atmosphere during the annealing was made a nitrogen atmosphere. On the other hand, samples for the VSM were made thin pieces taken from the center parts of width of the samples of ribbons from the six locations.

The results of measurement of the saturation magnetic flux density and iron loss are shown in Table 1 as averages of data of six locations.

TABLE 1

| | | | | | | | | | Saturation | |
|---|---|---|---|---|---|---|---|---|---|---|
| | | | | | | | | | magnetic | Iron loss |
| | | Chemical composition (atom %), balance: impurities | | | | | | | flux density | W_{13/50} |
| No. | | Fe | B | Si | C | Al | P | Mn | Bs (T) | (W/kg) |
| Inv. Ex. | 1 | 81.550 | 13.000 | 3.0 | 1.50 | 0.75 | 0.050 | 0.15 | 1.65 | 0.082 |
| Inv. Ex. | 2 | 78.000 | 15.880 | 3.0 | 2.00 | 1.00 | 0.020 | 0.10 | 1.62 | 0.086 |
| Inv. Ex. | 3 | 80.000 | 14.000 | 4.0 | 1.50 | 0.50 | — | — | 1.64 | 0.080 |
| Inv. Ex. | 4 | 84.000 | 12.000 | 2.0 | 1.50 | 0.50 | — | — | 1.67 | 0.080 |
| Inv. Ex. | 5 | 86.000 | 11.000 | 2.0 | 0.50 | 0.50 | — | — | 1.68 | 0.080 |
| Inv. Ex. | 6 | 81.710 | 14.000 | 3.0 | 1.00 | 0.10 | 0.040 | 0.15 | 1.65 | 0.090 |
| Inv. Ex. | 7 | 81.830 | 13.000 | 3.0 | 1.50 | 0.50 | 0.050 | 0.12 | 1.65 | 0.078 |
| Inv. Ex. | 8 | 79.820 | 14.000 | 3.0 | 1.50 | 1.50 | 0.030 | 0.15 | 1.63 | 0.090 |
| Inv. Ex. | 9 | 82.930 | 10.500 | 4.0 | 1.50 | 0.75 | 0.040 | 0.28 | 1.66 | 0.092 |
| Inv. Ex. | 10 | 78.000 | 16.868 | 3.0 | 1.50 | 0.50 | 0.012 | 0.12 | 1.62 | 0.092 |
| Inv. Ex. | 11 | 79.810 | 13.000 | 5.0 | 1.25 | 0.75 | 0.040 | 0.15 | 1.63 | 0.092 |
| Inv. Ex. | 12 | 81.700 | 10.500 | 5.0 | 2.00 | 0.50 | 0.050 | 0.25 | 1.65 | 0.093 |
| Inv. Ex. | 13 | 78.000 | 16.365 | 4.5 | 0.50 | 0.50 | 0.015 | 0.12 | 1.62 | 0.093 |
| Inv. Ex. | 14 | 80.805 | 15.000 | 3.0 | 1.00 | 0.005 | 0.040 | 0.15 | 1.64 | 0.094 |
| Inv. Ex. | 15 | 81.812 | 14.000 | 3.0 | 1.50 | 0.008 | 0.030 | 0.15 | 1.65 | 0.093 |
| Inv. Ex. | 16 | 81.088 | 15.000 | 3.0 | 0.20 | 0.50 | 0.012 | 0.20 | 1.64 | 0.084 |
| Inv. Ex. | 17 | 84.210 | 12.000 | 2.5 | 0.50 | 0.50 | 0.040 | 0.25 | 1.67 | 0.078 |
| Inv. Ex. | 18 | 78.820 | 15.000 | 3.5 | 2.00 | 0.50 | 0.030 | 0.15 | 1.63 | 0.078 |
| Comp. Ex. | 1 | 75.850 | 16.000 | 5.0 | 2.00 | 1.00 | 0.030 | 0.12 | 1.58 | 0.110 |
| Comp. Ex. | 2 | 86.670 | 10.000 | 2.0 | 0.50 | 0.50 | 0.080 | 0.25 | 1.69 | 0.120 |
| Comp. Ex. | 3 | 83.750 | 7.800 | 5.7 | 2.00 | 0.50 | 0.050 | 0.20 | 1.66 | 0.120 |
| Comp. Ex. | 4 | 78.000 | 18.835 | 2.0 | 0.50 | 0.50 | 0.015 | 0.15 | 1.62 | 0.120 |
| Comp. Ex. | 5 | 81.760 | 14.000 | 1.5 | 1.50 | 1.00 | 0.040 | 0.20 | 1.65 | 0.130 |
| Comp. Ex. | 6 | 79.820 | 10.000 | 9.2 | 0.30 | 0.50 | 0.030 | 0.15 | 1.63 | 0.120 |
| Comp. Ex. | 7 | 81.960 | 13.000 | 4.0 | 0.05 | 0.75 | 0.040 | 0.20 | 1.65 | 0.130 |
| Comp. Ex. | 8 | 80.085 | 10.800 | 3.0 | 5.20 | 0.75 | 0.015 | 0.15 | 1.64 | 0.130 |
| Comp. Ex. | 9 | 82.197 | 13.000 | 3.0 | 1.50 | 0.003 | 0.050 | 0.25 | 1.65 | 0.120 |
| Comp. Ex. | 10 | 79.810 | 13.500 | 3.0 | 1.50 | 2.00 | 0.040 | 0.15 | 1.63 | 0.140 |
| Comp. Ex. | 11 | 78.550 | 13.00 | 5.0 | 2.00 | 1.00 | 0.050 | 0.40 | 1.59 | 0.095 |

Underlines shown outside scope of present invention

As shown in Table 1, in each of Invention Examples 1 to 18, the alloy composition was inside the scope of the present invention, so the saturation magnetic flux density became 1.60 T or more, the iron loss (iron loss W_{13/50}) at a magnetic flux density 1.3 T and frequency 50 Hz became 0.095 W/kg or less, and a high saturation magnetic flux density and low iron loss could be simultaneously exhibited.

On the other hand, in each of Comparative Examples 1 to 10, the alloy composition was outside the scope of the present invention, so the iron loss (iron loss W_{13/50}) exceeded 0.095 W/kg. In Comparative Example 11, the alloy composition was outside the scope of the present invention, so the saturation magnetic flux density became less than 1.60 T.

That is, in Comparative Example 1, the Fe content was small, therefore the iron loss (iron loss W_{13/50}) exceeded 0.095 W/kg. Further, the saturation magnetic flux density became less than 1.60 T.

In Comparative Example 2, the Fe content was excessive, therefore the iron loss (iron loss W_{13/50}) exceeded 0.095 W/kg.

In each of Comparative Examples 3, and 4, the B content was outside the scope of the present invention, therefore the iron loss (iron loss W_{13/50}) exceeded 0.095 W/kg.

In each of Comparative Examples 5 and 6, the Si content was outside the scope of the present invention, therefore the iron loss (iron loss W_{13/50}) exceeded 0.095 W/kg.

In each of Comparative Examples 7 and 8, the C content was outside the scope of the present invention, therefore the iron loss (iron loss W_{13/50}) exceeded 0.095 W/kg.

In each of Comparative Examples 9 and 10, the Al content was outside the scope of the present invention, therefore the iron loss (iron loss W_{13/50}) exceeded 0.095 W/kg.

In Comparative Example 11, the Mn content was outside the scope of the present invention, therefore the saturation magnetic flux density became less than 1.60 T.

Note that, the Fe-based amorphous alloy ribbons were analyzed by X-ray diffraction, whereupon in each of Invention Examples 1 to 18 and Comparative Examples 1 to 11, no clear diffraction peaks were observed, so it cannot be said that any crystal phases were formed in the metallographic microstructure. The overall structure was an amorphous phase.

### Examples 2

An alloy of each of the various compositions of the alloy shown in Invention Example No. 1 of Table 1 in which part of the Fe was replaced with at least one of Ni, Cr, and Co was cast into a ribbon by an apparatus and conditions similar to Examples 1. Note that the specific composition of the alloy used was shown in Table 2. As a result, the thickness, width, and length of the obtained ribbon were respectively about 20 μm, 10 mm, and about 100 μm. The saturation magnetic flux density and iron loss of the obtained ribbon were evaluated. The method of obtaining samples and the measurement conditions used for evaluation of the properties of these were the same as in Examples 1. The results of measurement are shown in Table 2. Note that the display guidelines in Table 2 are similar to the case of Table 1.

TABLE 2

| | | | | | | | | | | | | Saturation | |
|---|---|---|---|---|---|---|---|---|---|---|---|---|---|
| | | | | | | | | | | | | magnetic | Iron loss |
| | | Chemical composition (atom %), balance: impurities | | | | | | | | | | flux density | W_{13/50} |
| No. | | Fe | B | Si | C | Al | P | Mn | Ni | Cr | Co | Bs (T) | (W/kg) |
| Inv. Ex. | 19 | 80.550 | 13.000 | 3.0 | 1.50 | 0.75 | 0.050 | 0.15 | 1.0 | — | — | 1.64 | 0.084 |
| Inv. Ex. | 20 | 80.050 | 13.000 | 3.0 | 1.50 | 0.75 | 0.050 | 0.15 | — | 1.5 | — | 1.63 | 0.084 |
| Inv. Ex. | 21 | 79.550 | 13.000 | 3.0 | 1.50 | 0.75 | 0.050 | 0.15 | — | — | 2.0 | 1.65 | 0.082 |
| Inv. Ex. | 22 | 78.050 | 13.000 | 3.0 | 1.50 | 0.75 | 0.050 | 0.15 | 1.5 | 2.0 | — | 1.63 | 0.086 |
| Inv. Ex. | 23 | 76.550 | 13.000 | 3.0 | 1.50 | 0.75 | 0.050 | 0.15 | — | 2.0 | 3.0 | 1.63 | 0.084 |
| Inv. Ex. | 24 | 74.550 | 13.000 | 3.0 | 1.50 | 0.75 | 0.050 | 0.15 | 3.0 | — | 4.0 | 1.62 | 0.082 |
| Inv. Ex. | 25 | 72.550 | 13.000 | 3.0 | 1.50 | 0.75 | 0.050 | 0.15 | 2.0 | 3.0 | 4.0 | 1.62 | 0.084 |

As clear from the results of Sample Nos. 19 to 25 of Table 2, it was learned that even if replacing part of the Fe with one or more elements of Ni, Cr, and Co in 10.0 atom % or less in range, the saturation magnetic flux density is 1.60 T or more and the iron loss can be stably kept at 0.095 W/kg or less at W_{13/50}. Further, in each sample, no clear diffraction peaks were observed in X-ray diffraction analysis. It was confirmed that each was amorphous.

As explained above, in the Fe-based amorphous alloy and Fe-based amorphous alloy ribbon of the present invention, by including Al, by optimizing the contents of B, Si, and C, and further by making the content of Fe 78.00% or more, the iron loss (iron loss W_{13/50}) at the magnetic flux density 1.3 T and frequency 50 Hz becomes 0.095 W/kg or less, the saturation magnetic flux density becomes 1.60 T or more, and excellent soft magnetic properties were exhibited.

### Examples 3

An alloy of each of the various compositions shown in Table 3 was melted in an argon atmosphere and quenched and cast by a single roll apparatus so as to prepare a ribbon of an Fe-based amorphous alloy. The casting atmosphere was the air. Note that, the single roll apparatus used was comprised of a diameter 300 mm copper alloy cooling roll, a high frequency power source for melting a sample, a quartz crucible with a slot nozzle at the front end, etc. In this test, a length 10 mm, width 0.6 mm slot nozzle was used. The peripheral speed of the cooling roll was made 24 m/s. As a result, the thickness of the obtained ribbon was about 25 μm. The width depends on the length of the slot nozzle, so was 10 mm. The length was around 120 m.

The saturation magnetic flux density and iron loss of the obtained ribbon were evaluated. The method of obtaining the samples and the measurement conditions used for evaluation of the properties of these were the same as in Examples 1. The results of measurement are shown in Table 3. Note that the display guidelines in Table 3 are similar to the case of Table 1.

Furthermore, to evaluate the brittleness, a 60 mm width ribbon was cast. A length 60 mm, width 0.6 mm slot nozzle was used and the peripheral speed of the cooling roll was made 24 m/s. As a result, the thickness of the obtained ribbon was about 25 m. The width is dependent on the length of the slot nozzle, so was 60 mm. The length was about 20 m. Further, the workability of the Fe-based amorphous alloy ribbon was examined based on the evaluation of the strip tear ductility prescribed in JIS C 2534: 2017. Specifically, as a test piece, a length 2.4 m test use ribbon was cut out from a length approximately 20 m cast ribbon. This was made the test piece. The ribbon was tom in a direction parallel to the casting direction at 12.7 mm and 25.4 mm from the two cast edges of the test piece in the width direction and at five locations at the center in the width direction. The number of the brittle spots of about 6 mm or more dimensions caused by changes in the path and/or direction of the tears or breaking into pieces were counted. The total number of these brittle spots of one test piece was found and the brittleness code was determined based on the following criteria. Brittleness Codes 1 to 4 were deemed passing. The results are shown in Table 3.
Brittleness Code 1: Total number of brittle spots 0
Brittleness Code 2: Total number of brittle spots 1 to 3
Brittleness Code 3: Total number of brittle spots 4 to 6
Brittleness Code 4: Total number of brittle spots 7 to 9
Brittleness Code 5: Total number of brittle spots 10 or more

TABLE 3

| | | | | | | | | | | Saturation | | |
|---|---|---|---|---|---|---|---|---|---|---|---|---|
| | | | | | | | | | | magnetic | Iron loss | Brittle- |
| | | Chemical composition (atom %), balance: impurities | | | | | | | | flux density | W_{13/50} | ness |
| No. | | Fe | B | Si | C | Al | P | Mn | P + Al | Bs (T) | (W/kg) | code |
| Inv. Ex. | 26 | 81.80 | 11.0 | 5.0 | 1.00 | 0.50 | 0.50 | 0.20 | 1.00 | 1.64 | 0.084 | 3 |
| Inv. Ex. | 27 | 79.95 | 12.0 | 6.0 | 1.00 | 0.50 | 0.40 | 0.15 | 0.90 | 1.62 | 0.084 | 2 |
| Inv. Ex. | 28 | 78.10 | 13.0 | 7.0 | 1.00 | 0.40 | 0.50 | — | 0.90 | 1.60 | 0.084 | 2 |
| Inv. Ex. | 29 | 83.90 | 10.0 | 4.0 | 1.00 | 0.50 | 0.60 | — | 1.10 | 1.66 | 0.084 | 3 |
| Inv. Ex. | 30 | 85.90 | 9.0 | 3.0 | 1.00 | 0.60 | 0.50 | — | 1.10 | 1.68 | 0.088 | 3 |
| Inv. Ex. | 31 | 82.15 | 11.0 | 5.0 | 1.30 | 0.20 | 0.10 | 0.25 | 0.30 | 1.64 | 0.092 | 2 |
| Inv. Ex. | 32 | 81.30 | 10.0 | 7.0 | 1.45 | 0.005 | 0.10 | 0.15 | 0.105 | 1.63 | 0.094 | 1 |
| Inv. Ex. | 33 | 79.58 | 13.0 | 5.0 | 1.00 | 0.70 | 0.60 | 0.12 | 1.30 | 1.62 | 0.080 | 3 |
| Inv. Ex. | 34 | 80.30 | 12.0 | 5.0 | 1.00 | 1.00 | 0.50 | 0.20 | 1.50 | 1.63 | 0.080 | 4 |
| Inv. Ex. | 35 | 81.20 | 9.0 | 7.0 | 2.00 | 0.30 | 0.30 | 0.20 | 0.60 | 1.63 | 0.092 | 3 |
| Inv. Ex. | 36 | 78.08 | 16.0 | 4.0 | 1.00 | 0.40 | 0.40 | 0.12 | 0.80 | 1.60 | 0.090 | 3 |
| Inv. Ex. | 37 | 81.40 | 14.0 | 2.5 | 1.00 | 0.50 | 0.40 | 0.20 | 0.90 | 1.64 | 0.088 | 3 |
| Inv. Ex. | 38 | 78.95 | 10.0 | 9.0 | 1.00 | 0.40 | 0.50 | 0.15 | 0.90 | 1.61 | 0.086 | 3 |
| Inv. Ex. | 39 | 80.35 | 12.0 | 6.0 | 0.50 | 0.50 | 0.50 | 0.15 | 1.00 | 1.63 | 0.086 | 3 |
| Inv. Ex. | 40 | 81.30 | 10.0 | 3.0 | 4.50 | 0.50 | 0.50 | 0.20 | 1.00 | 1.64 | 0.086 | 3 |
| Inv. Ex. | 41 | 79.76 | 14.0 | 5.0 | 1.00 | 0.10 | 0.02 | 0.12 | 0.12 | 1.62 | 0.092 | 2 |
| Inv. Ex. | 42 | 80.45 | 13.0 | 4.0 | 1.00 | 0.50 | 0.90 | 0.15 | 1.40 | 1.63 | 0.084 | 3 |
| Inv. Ex. | 43 | 80.10 | 14.0 | 5.0 | 0.50 | 0.05 | 0.20 | 0.15 | 0.25 | 1.62 | 0.094 | 1 |
| Inv. Ex. | 44 | 78.48 | 11.0 | 6.0 | 3.00 | 0.70 | 0.70 | 0.12 | 1.40 | 1.61 | 0.080 | 4 |
| Inv. Ex. | 45 | 78.48 | 14.0 | 6.0 | 0.60 | 0.40 | 0.40 | 0.12 | 0.80 | 1.61 | 0.086 | 2 |
| Inv. Ex. | 46 | 78.48 | 13.5 | 3.5 | 3.50 | 0.40 | 0.50 | 0.12 | 0.90 | 1.61 | 0.084 | 3 |
| Inv. Ex. | 47 | 78.95 | 10.5 | 6.0 | 3.50 | 0.50 | 0.40 | 0.15 | 0.90 | 1.61 | 0.084 | 3 |
| Inv. Ex. | 48 | 80.00 | 11.0 | 4.0 | 4.00 | 0.50 | 0.30 | 0.20 | 0.80 | 1.62 | 0.086 | 3 |
| Inv. Ex. | 49 | 80.50 | 10.5 | 7.0 | 1.00 | 0.30 | 0.50 | 0.20 | 0.80 | 1.63 | 0.086 | 2 |
| Inv. Ex. | 50 | 80.60 | 14.0 | 3.5 | 1.00 | 0.30 | 0.40 | 0.20 | 0.70 | 1.63 | 0.088 | 2 |
| Inv. Ex. | 51 | 84.40 | 9.0 | 4.0 | 1.00 | 0.70 | 0.70 | 0.20 | 1.40 | 1.66 | 0.082 | 3 |
| Inv. Ex. | 52 | 84.50 | 9.0 | 4.0 | 2.00 | 0.10 | 0.20 | 0.20 | 0.30 | 1.66 | 0.090 | 2 |
| Comp. Ex. | 12 | 76.88 | 14.0 | 7.0 | 1.00 | 0.50 | 0.50 | 0.12 | 1.00 | 1.59 | 0.090 | 3 |
| Comp. Ex. | 13 | 86.15 | 8.0 | 4.0 | 0.50 | 0.50 | 0.60 | 0.25 | 1.10 | 1.68 | 0.120 | 3 |
| Comp. Ex. | 14 | 82.90 | 7.5 | 6.5 | 2.00 | 0.40 | 0.50 | 0.20 | 0.90 | 1.65 | 0.130 | 3 |
| Comp. Ex. | 15 | 78.05 | 16.5 | 4.0 | 0.50 | 0.40 | 0.40 | 0.15 | 0.80 | 1.60 | 0.120 | 3 |
| Comp. Ex. | 16 | 82.80 | 13.0 | 1.9 | 1.00 | 0.50 | 0.60 | 0.20 | 1.10 | 1.65 | 0.110 | 3 |
| Comp. Ex. | 17 | 80.20 | 8.0 | 9.5 | 1.00 | 0.50 | 0.60 | 0.20 | 1.10 | 1.62 | 0.120 | 3 |
| Comp. Ex. | 18 | 81.57 | 10.0 | 7.0 | 0.08 | 0.60 | 0.50 | 0.25 | 1.10 | 1.64 | 0.130 | 4 |
| Comp. Ex. | 19 | 80.35 | 8.0 | 5.0 | 5.50 | 0.50 | 0.50 | 0.15 | 1.00 | 1.63 | 0.120 | 3 |
| Comp. Ex. | 20 | 80.48 | 12.0 | 5.0 | 1.00 | 0.30 | 1.10 | 0.12 | 1.40 | 1.63 | 0.105 | 5 |
| Comp. Ex. | 21 | 80.076 | 13.0 | 5.0 | 1.00 | 0.004 | 0.80 | 0.12 | 0.808 | 1.62 | 0.120 | 2 |
| Comp. Ex. | 22 | 79.75 | 12.0 | 5.0 | 1.00 | 1.55 | 0.50 | 0.20 | 2.05 | 1.61 | 0.092 | 5 |
| Comp. Ex. | 23 | 81.716 | 11.0 | 6.0 | 1.00 | 0.004 | 0.08 | 0.20 | 0.084 | 1.64 | 0.140 | 2 |
| Comp. Ex. | 24 | 80.25 | 12.0 | 5.0 | 1.00 | 0.50 | 1.10 | 0.15 | 1.60 | 1.62 | 0.110 | 3 |
| Comp. Ex. | 25 | 78.60 | 13.0 | 5.0 | 2.00 | 0.50 | 0.50 | 0.40 | 1.00 | 1.59 | 0.095 | 2 |

Underlines shown outside scope of present invention

As shown in Table 3, in each of Invention Examples 26 to 52, the alloy composition was within the scope of the present invention, so the saturation magnetic flux density became 1.60 T or more, the iron loss (iron loss W_{13/50}) at a magnetic flux density 1.3 T and frequency 50 Hz became 0.095 W/kg or less, and a high saturation magnetic flux density and low iron loss could be simultaneously exhibited. Further, in each case, the Brittleness Code became 1 to 4 and the workability was also excellent.

On the other hand, in each of Comparative Examples 12 to 25, the alloy composition was outside the scope of the present invention, so the iron loss (iron loss W_{13/50}) became more than 0.095 W/kg, the saturation magnetic flux density became less than 1.60 T, or the Brittleness Code became 5.

Note that, the Fe-based amorphous alloy ribbon was analyzed by X-ray diffraction, whereupon in all of Invention Examples 26 to 52 and Comparative Examples 12 to 25, no clear diffraction peaks were observed, so it cannot be said that crystalline phases were formed in the metallographic structures and the structures overall were amorphous phases.

### Examples 4

The alloy shown in Invention Example No. 26 of Table 3 was cast into a ribbon by an apparatus and conditions similar to Examples 1 using alloys of various compositions in which part of the Fe was replaced with at least one of Ni, Cr, and Co. Note that the specific composition of the alloy used was shown in Table 2. The thickness, width, and length of the ribbon obtained using a length 10 mm, width 0.6 mm slot nozzle were respectively about 25 μm, 10 mm, and about 120 m. Further, the thickness, width, and length of the ribbon obtained using a length 60 mm, width 0.6 mm slot nozzle were respectively about 25 μm, 60 mm, and about 20 m. The saturation magnetic flux density and iron loss and the strip tear ductility of the obtained ribbon were evaluated. The method of obtaining the samples and the measurement conditions used for evaluation of the properties of these were the same as in Examples 3. The results of measurement are shown in Table 4. Note that the display guidelines in Table 4 are similar to the case of Table 1.

TABLE 4

| | | | | | | | | | | | | | Saturation | Iron | |
|---|---|---|---|---|---|---|---|---|---|---|---|---|---|---|---|
| | | | | | | | | | | | | | magnetic | loss | Brittle- |
| | | Chemical composition (atom %), balance: impurities | | | | | | | | | | | flux density | W_{13/50} | ness |
| No. | | Fe | B | Si | C | Al | P | Mn | Ni | Cr | Co | P + Al | Bs (T) | (W/kg) | code |
| Inv. Ex. | 53 | 80.80 | 11.0 | 5.0 | 1.00 | 0.50 | 0.50 | 0.20 | 1.00 | | | 1.00 | 1.65 | 0.084 | 2 |
| Inv. Ex. | 54 | 78.80 | 11.0 | 5.0 | 1.00 | 0.50 | 0.50 | 0.20 | | 3.00 | | 1.00 | 1.63 | 0.084 | 3 |
| Inv. Ex. | 55 | 79.80 | 11.0 | 5.0 | 1.00 | 0.50 | 0.50 | 0.20 | | | 2.00 | 1.00 | 1.66 | 0.082 | 2 |
| Inv. Ex. | 56 | 76.80 | 11.0 | 5.0 | 1.00 | 0.50 | 0.50 | 0.20 | 3.00 | 2.00 | | 1.00 | 1.65 | 0.084 | 3 |
| Inv. Ex. | 57 | 75.80 | 11.0 | 5.0 | 1.00 | 0.50 | 0.50 | 0.20 | 3.00 | | 3.00 | 1.00 | 1.66 | 0.082 | 2 |
| Inv. Ex. | 58 | 74.80 | 11.0 | 5.0 | 1.00 | 0.50 | 0.50 | 0.20 | | 3.00 | 4.00 | 1.00 | 1.65 | 0.084 | 3 |
| Inv. Ex. | 59 | 72.80 | 11.0 | 5.0 | 1.00 | 0.50 | 0.50 | 0.20 | 2.00 | 4.00 | 3.00 | 1.00 | 1.66 | 0.084 | 2 |

As clear from the results of Sample Nos. 53 to 59 of Table 4, it was learned that even if replacing part of the Fe with at least one element of Ni, Cr, and Co in 10.0 atom % or less in range, the saturation magnetic flux density is 1.60 T or more and the iron loss W_{13/50} can be stably made 0.095 W/kg or less. Further, in each sample, the Brittleness Code became 2 to 3 and the workability was excellent. Furthermore, in each sample, no clear diffraction peaks were observed in X-ray diffraction analysis. It was confirmed that the structure was amorphous.

As explained above, the Fe-based amorphous alloy and Fe-based amorphous alloy ribbon of the present invention are made to contain Al, are optimized in contents of B, Si, C, and P, and further have contents of Fe of 78% or more whereby the iron loss at a magnetic flux density 1.3 T and frequency 50 Hz (iron loss W_{13/50}) became 0.095 W/kg or less, the saturation magnetic flux density became 1.60 T or more, and excellent soft magnetic properties were exhibited. Further, the workability was also excellent.

1. An Fe-based amorphous alloy comprising, by atom %,
B: 8.0% or more and 18.0% or less,
Si: 2.0% or more and 9.0% or less,
C: 0.10% or more and 5.00% or less,
Al: 0.005% or more and 1.50% or less,
P: 0% or more and less than 1.00%,
Mn: 0% or more and 0.30% or less,
Fe: 78.00% or more and 86.00% or less, and
balance: impurities and
having an amorphous structure.

2. The Fe-based amorphous alloy according to claim 1, wherein, by atom %,
the content of B is 10.0% or more and 18.0% or less,
the content of Si is 2.0% or more and 6.0% or less,
the content of C is 0.10% or more and less than 3.00%, and
the content of P is 0% or more and 0.05% or less.

3. The Fe-based amorphous alloy according to claim 1, wherein, by atom %,
the content of B is 11.0% or more and 16.0% or less,
the content of Si is 2.0% or more and 4.0% or less,
the content of C is 0.10% or more and less than 3.00%, and
the content of P is 0% or more and 0.05% or less.

4. The Fe-based amorphous alloy according to claim 1, wherein, by atom %,
the content of B is 8.0% or more and 16.0% or less,
the content of Si is more than 2.0% and 9.0% or less,
the content of Al is 0.005% or more and 1.00% or less, and
the content of P is 0.01% or more and less than 1.00% and
the sum of the contents of P and Al 0.10% or more and 1.50% or less.

5. The Fe-based amorphous alloy according to claim 1, wherein, by atom %,
the content of B is 8.0% or more and 15.0% or less,
the content of Si is more than 3.0% and 7.5% or less,
the content of C is 0.50% or more and 5.00% or less,
the content of Al is 0.01% or more and 0.80% or less,
the content of P is 0.01% or more and 0.80% or less, and
the content of Fe is 78.00% or more and 85.00% or less and
the sum of the contents of P and Al is 0.10% or more and 1.50% or less.

6. The Fe-based amorphous alloy according to claim 1, wherein, by atom %,
the content of B is 10.0% or more and 16.0% or less,
the content of Si is more than 2.0% and 6.0% or less,
the content of C is 0.10% or more and less than 3.00%,
the content of Al is 0.01% or more and 1.00% or less,
the content of P is 0.01% or more and less than 1.00%, and
the content of Fe is 78.00% or more and 84.00% or less and
the sum of the contents of P and Al is 0.10% or more and 1.50% or less.

7. The Fe-based amorphous alloy according to claim 1, wherein at least one or more elements among Ni, Cr, and Co replaces the Fe in 10.0 atom % or less in range.

8. An Fe-based amorphous alloy ribbon comprised of the Fe-based amorphous alloy according to claim 1.

9. An Fe-based amorphous alloy ribbon comprised of the Fe-based amorphous alloy according to claim 7.

10. The Fe-based amorphous alloy according to claim 2, wherein at least one or more elements among Ni, Cr, and Co replaces the Fe in 10.0 atom % or less in range.

11. The Fe-based amorphous alloy according to claim 3, wherein at least one or more elements among Ni, Cr, and Co replaces the Fe in 10.0 atom % or less in range.

12. The Fe-based amorphous alloy according to claim 4, wherein at least one or more elements among Ni, Cr, and Co replaces the Fe in 10.0 atom % or less in range.

13. The Fe-based amorphous alloy according to claim 5, wherein at least one or more elements among Ni, Cr, and Co replaces the Fe in 10.0 atom % or less in range.

14. The Fe-based amorphous alloy according to claim 6, wherein at least one or more elements among Ni, Cr, and Co replaces the Fe in 10.0 atom % or less in range.

15. An Fe-based amorphous alloy ribbon comprised of the Fe-based amorphous alloy according to claim 2.

16. An Fe-based amorphous alloy ribbon comprised of the Fe-based amorphous alloy according to claim 3.

17. An Fe-based amorphous alloy ribbon comprised of the Fe-based amorphous alloy according to claim 4.

18. An Fe-based amorphous alloy ribbon comprised of the Fe-based amorphous alloy according to claim 5.

19. An Fe-based amorphous alloy ribbon comprised of the Fe-based amorphous alloy according to claim 6.
